(19) United States
(12) Patent Application Publication
(10) Pub. No.: US 2010/0070427 A1
(43) Pub. Date: Mar. 18, 2010

(54) DYNAMIC INDEXING

(75) Inventors: Dennis Rakhamimov, Palo Alto, CA (US); Eric Poirier, San Carlos, CA (US)

Correspondence Address: HICKMAN PALERMO TRUONG & BECKER, LLP, 2055 GATEWAY PLACE, SUITE 550, SAN JOSE, CA, 95110, US

(73) Assignee: PALANTIR TECHNOLOGIES, INC., Palo Alto, CA (US)

(21) Appl. No.: 12/210,980

(22) Filed: Sep. 15, 2008

(51) Int. Cl. G06Q 40/00; G06F 17/30; G06F 7/06

(52) U.S. Cl. 705/36 R; 707/E17.014; 707/E17.044

(57) ABSTRACT

Techniques for dynamic indexing are provided. In one embodiment, first instruments to be included in an index are identified at a first time. The index includes one or more first weights each of which is associated with a different instrument in the first instruments. One or more first time series for the first instruments are determined. Based on the one or more first time series and the one or more first weights, a collective value of the index is tracked as a function of time at least from the first time. At least one of a) the first weights and the first time, and b) the collective value as the function of the time is stored, in a physical storage device.

### FIELD OF THE DISCLOSURE

The present disclosure generally relates to techniques for analyzing large data sets, for example, as related to market instruments.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Trades of specific market instruments are influenced by diverse factors. For example, trades of shares in a mining company may be influenced by the present or pending supply and demand situation in a particular commodity market, while trades of shares in a retailer may be influenced by a consumer mood at a particular time. To capture trends in the markets, a myriad of commercial indexes have been created. Some commercial indexes such as the Dow Jones 30 or S&P 500 are made up of large-cap or medium-cap corporations across various sectors, while other commercial indexes are made up of representative corporations in certain sectors or sizes.

These indexes may indicate overall trends that are otherwise masked by diverse factors affecting individual market instruments. A shortcoming of these commercial indexes, however, is that these indexes are static and lag behind changes in the economy. For example, a fast growing, innovative company that uses a new mode of business may not be recognized in any of the commercial indexes for years. Indeed, it typically takes months, if not years, for these indexes to make some slight adjustment in their composition of market instruments.

An analyst may decide to define private indexes. However, these indexes typically are defined in manual and cumbersome ways, and may be dependent on the analyst's empirical knowledge, hunches, and subjective assessment. Thus, these indexes, while theoretically changeable on a whim, are still biased, incomplete, and difficult to maintain.

The indexes may be capture data in an over-simplified and relatively static manner. These indexes cannot keep up with new variables and new trends appearing in markets, and therefore can hardly yield reliable, useful insights for future performance of the markets and instruments. These indexes typically provide little support for a user to promptly make reliable and objective adjustments.

### SUMMARY

In an embodiment, a computer-implemented method comprises identifying one or more first instruments to be included in an index at a first time and one or more first weights each of which is associated with a different instrument in the one or more first instruments; determining one or more first time series for the first instruments; tracking, based on the one or more first time series and the one or more first weights, a collective value of the index as a function of time at least from the first time; and storing, in a physical storage device, at least one of a) the first weights and the first time, and b) the collective value as the function of the time.

In a feature of this embodiment, the method further comprises associating the index with a computational metric that defines a function that can operate on the first instruments as input and yield metric output values, and determining the one or more first weights based on a relationship to the metric output values for the instruments.

In an aspect of this feature, in the method, the one or more first weights are determined as proportional to the metric output values. In another aspect of this feature, in the method, the one or more first weights are determined as inversely proportional to the metric output values. In a further aspect of this feature, the method also comprises determining the one or more first weights based on a relationship of market values of the first instruments at a particular time. In still another aspect of this feature, in the method, the function is not market value.

In an feature of the embodiment, the method further comprises receiving user input that identifies one or more second instruments to be included in the index at a second time, and one or more second weights, each of which is associated with a different instrument in the one or more second instruments; receiving second user input that specifies a date set; and for each date in the date set, rebalancing the index based on determining a collective market value of the first instruments at that date, removing the first instruments from the index, adding the second instruments to the index, and using the second weights to distribute the collective market value among the second instruments.

In an aspect of this feature, the method further comprises performing the rebalancing on end dates of one or more of the first instruments.

In another aspect of this feature, the method further comprises receiving user input requesting data details for the index; and in response to the user input, displaying a table comprising dates of the date set, a number of instruments in the index on each of the dates, a number of instruments included in the index on each of the dates, and a number of instruments removed from the index on each of the dates. Additionally and/or optionally, in this aspect of this feature, the method may further comprises receiving user input selecting one of the dates in the table, and in response, displaying for each of the first instruments and the second instruments: instrument name; an indication whether that instrument was included in the index on the selected date; an indication whether that instrument was removed from the index on the selected date; and an instrument weight value for that instrument at the selected date.

In some embodiments, the collective value as mentioned above is an analytical value of the index.

Other embodiments may comprise a system, an apparatus, and one or more machine-readable storage media operable to provide the foregoing graphical user interface and/or to perform or cause the performance of the foregoing computer-implemented methods.

### BRIEF DESCRIPTION OF THE DRAWINGS

FIG. 1 illustrates an example data analysis system for dynamic indexing.

FIG. 2A illustrates an example graphical user interface related to a simple indexe.

FIG. 2B illustrates an example graphical user interface related to weighting criteria.

FIG. 2C illustrates an example graphical user interface related to an instrument group.

FIG. 2D illustrates an example graphical user interface related to rebalancing.

FIG. 2E illustrates an example graphical user interface related to a collective analytical value.

FIG. 2F illustrates an example graphical user interface related to displaying an index.

FIG. 2G illustrates an example graphical user interface related to a detailed index information display.

FIG. 3 illustrates an example process flow.

FIG. 4 illustrates a computer system with which an embodiment may be implemented.

### DESCRIPTION OF EXAMPLE EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

1. Glossary of Terms

In this description, the following terms have the following meanings.

Collective value: any type of aggregate value of the one or more instruments. The collective value may be of a market value type such as a total monetary value of the one or more instruments traded at public exchanges, or of an analytical value type such as a numeric value indicating volatility of the trading price for the one or more instruments, as a function of time over the set of time values.

Data item: a zero-order object that can be described by a number of properties and/or metrics. Frame: a graphical representation object that is configurable to include one or more GUI components. Examples of frames include, but are not limited to, dialog boxes, forms, and other types of windows or graphical containers.

Market value: a market value of an instrument or an aggregation of values of all assets included in a portfolio or an index. The market value may be measured (e.g., denominated) in a reference currency such as the U.S. dollar. For example, a value of an asset such as an instrument may be a trading price of that instrument at the closing of a particular trading day. A value of the reference currency may be its trading value as denominated in the reference currency. A value of a currency that is not the reference currency may also be measured in the reference currency through an exchange rate.

Metrics: broadly refers to a piece of computation that yields a result. For example, a particular metric may be computation that yields a volatility value of an instrument.

Rebalance: an act of a re-allocation of a collective value among one, two or more instruments, perhaps based on weight values.

Time series: a type of objects which are used in the data analysis system to represent time-dependent information. These first time series provide individual market values or individual metric values of the first instruments over the time period when the first instruments are included in the index.

2. Example Data Analysis System

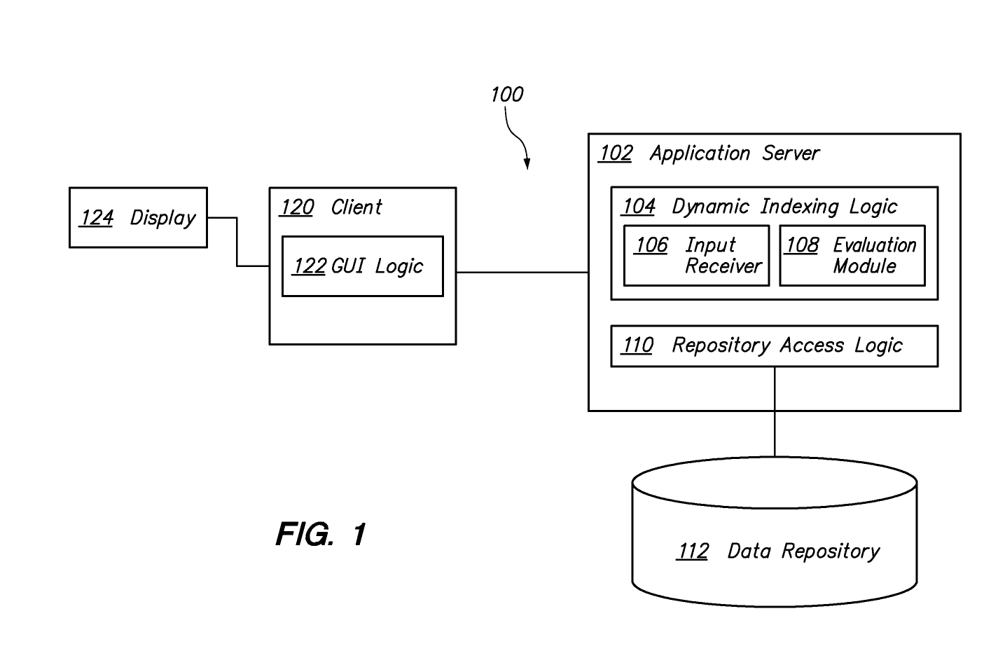

FIG. 1 illustrates an example data analysis system for tracking a collective value of data items. Data analysis system 100 comprises application server 102 and one or more clients, such as client 120.

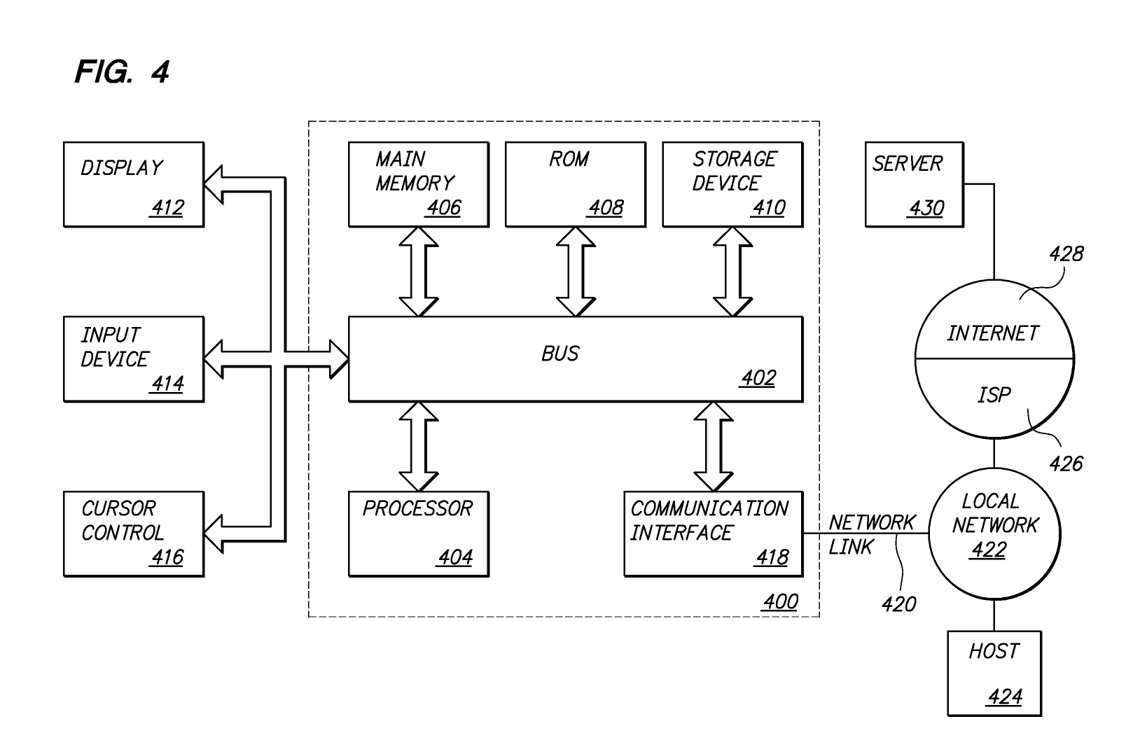

In the embodiment illustrated in FIG. 1, client 120, which may be implemented by one or more first physical computing devices, is communicatively connected to application server 102, which may be implemented by one or more second physical computing devices, over a network. In some embodiments, each such physical computing device may be implemented as a separate computer system as shown in FIG. 4. For example, client 120 may be implemented in a computer system as a set of program instructions recorded on a machine-readable storage medium, while application server 102 may be implemented in a different computer system.

Client 120 comprises graphical user interface (GUI) logic 122. GUI logic 122 may be a set of program instructions which, when executed by one or more processors of the computer system, are operable to receive user input and to display a graphical representation of one or more graphic constructs related to tracking a collective value of data items using the approaches herein. GUI logic 122 may be operable to receive user input from, and display the graphic constructs to, a graphical user interface that is provided on display 124 by the computer system on which client 120 executes.

In some embodiments, GUI logic 122 is omitted. For example, in one embodiment, client 120 may comprise an application program or process that issues one or more function calls or application programming interface (API) calls to application server 102 to obtain information resulting from, to provide input to, and to execute along with application server 102, the processes or one or more steps thereof as described herein. For example, client 120 may request and obtain a representation of a group of data items as described herein using a programmatic interface, and then the client may use, process, log, store, or otherwise interact with the received data according to local logic.

Client 120 may also interact with application server 102 to provide input, definition, editing instructions, expressions related to one or more dynamic indexes as described herein using a programmatic interface, and then the application server 102 may use, process, log, store, or otherwise interact with the received input according to application server logic.

Application server 102 may be implemented as a special-purpose computer system having the logical elements shown in FIG. 1. In an embodiment, the logical elements may comprise program instructions recorded on one or more machine-readable storage media. Alternatively, the logical elements may be implemented in hardware, firmware, or a combination.

When executed by one or more processors of the computer system, logic in application server 102 is operable to track the collective value of data items according to the techniques described herein. In one embodiment, application server 102 may be implemented in a Java Virtual Machine (JVM) that is executing in a distributed or non-distributed computer system. In other embodiments, application server 102 may be implemented as a combination of programming instructions written in any programming language (e.g. C++ or Visual Basic) and hardware components (e.g. memory, CPU time) that have been allocated for executing the program instructions.

In an embodiment, application server 102 comprises repository access logic 110 and dynamic indexing logic 104. Repository access logic 110 may comprise a set of program instructions which, when executed by one or more processors, are operable to access and retrieve data from data repository 112. For example, repository access logic 110 may be a database client or an Open Database Connectivity (ODBC) client that supports calls to a database server that manages data repository 112. Data repository 112 may be any type of structured storage for storing data including, but not limited to, relational or object-oriented databases, data warehouses, directories, data files, and any other structured data storage.

In the embodiment illustrated in FIG. 1, dynamic indexing logic 104 comprises input receiver 106 and evaluation module 108. Dynamic indexing logic 104 may be object-oriented logic. As used herein, the data items can be accessed and/or operated by the dynamic indexing logic 104 to create, modify, delete, and store the data generated or used by data analysis system 100.

In an embodiment, input receiver 106 is a set of program instructions which, when executed by one or more processors, are operable to receive input from a client.

Evaluation module 108 is a set of program instructions that implement logic to create, modify, delete and store dynamic indexes that are associated with the data items, evaluate these objects when instructed to do so by data analysis system 100, provide the evaluation results to a client. Evaluation results of one or more objects may also be rendered by GUI logic 122 on display 120.

3. Example Definition of Indexes

3.2 Graphical User Interfaces

For purposes of clearly illustrating dynamic indexing, the following sections describe example graphical user interface displays. However, the GUI displays described herein represent only selected examples of visualizations dynamic indexing described herein. In other embodiments, other graphical user interface displays may be used to interact with a user in connection with dynamic indexing.

Furthermore, no particular GUI is required and the disclosure is intended to encompass dynamic indexing described independent of any GUI, and is not intended to be limited to any particular GUI or other form of display. For example, each example GUI merely represents one way to receive data input from a user for the data elements, parameters and values that are shown in the GUI, and represents only one way to display output resulting from the transformations and manipulations described herein; in other embodiments, programmatic methods may be used to obtain the same data elements, parameters and values and other forms of data output may be used such as logging, reporting, storing in database tables, storing in spreadsheets, or output using the GUI of another program or process. Moreover, as described above, in some embodiments no graphical user interface is used at all.

3.3 Simple Index

In an embodiment, users can create their own synthetic, dynamic indexes using the data analysis system 100. For the purpose of illustration, data items are instruments. A user starts out with a sum of $100 and would like to invest the sum in an index from a start date. The index may be made of one, two, or more instruments in various embodiments.

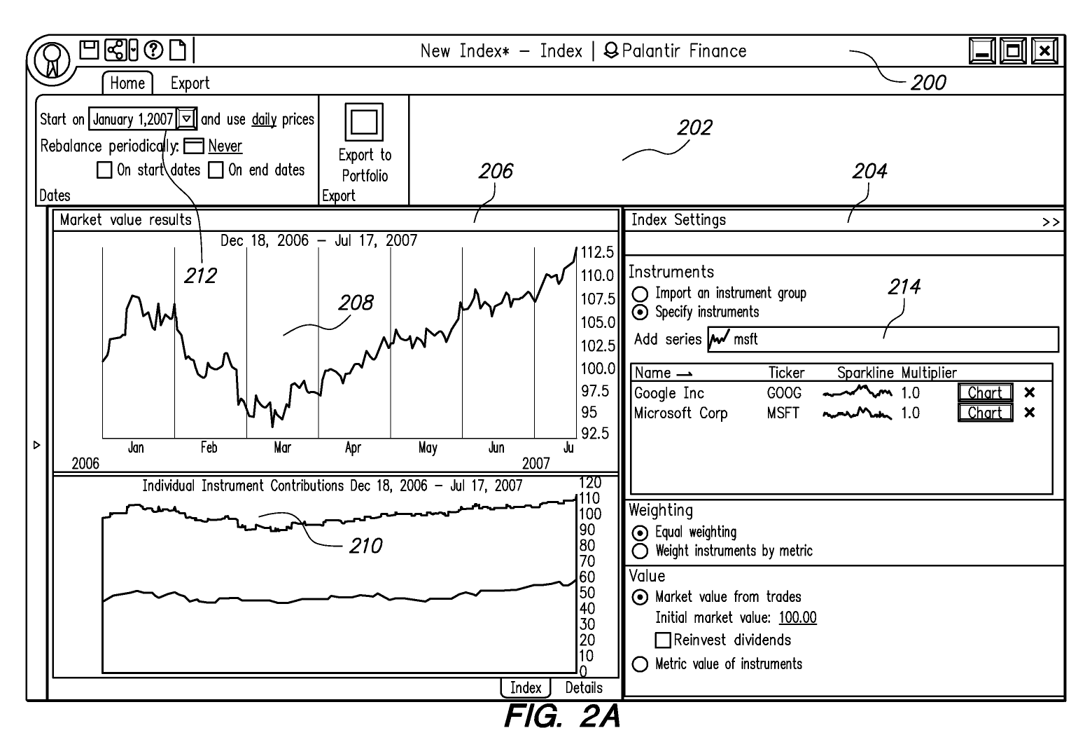

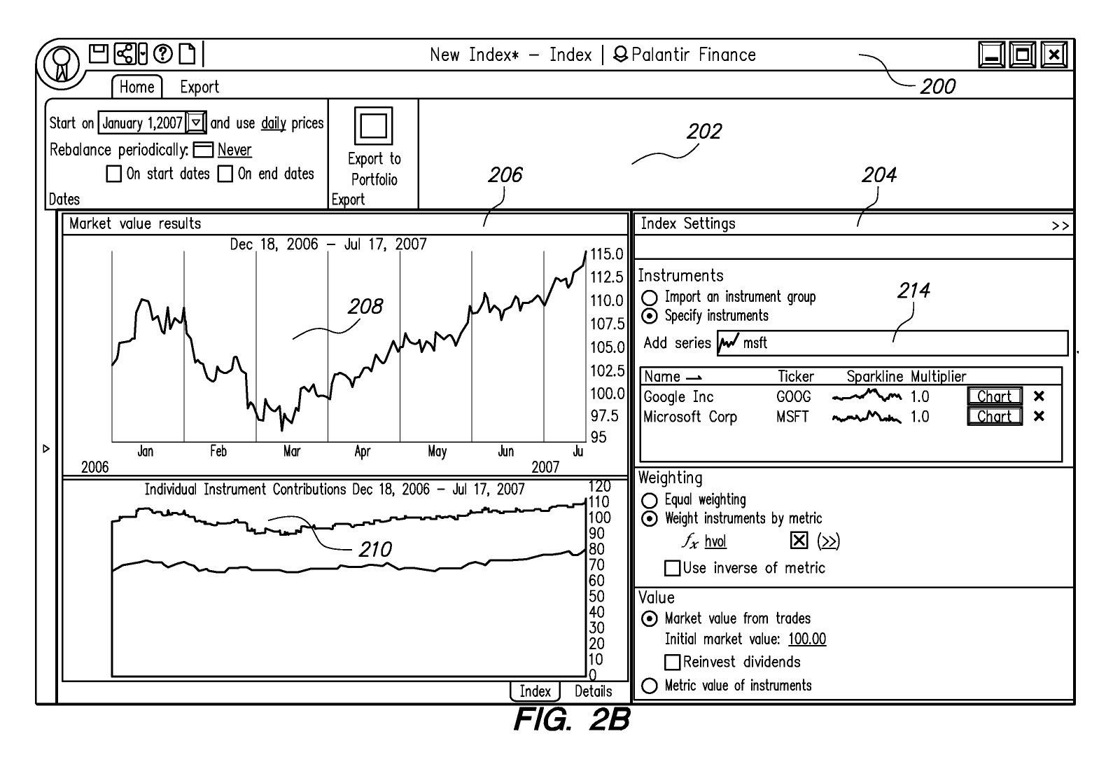

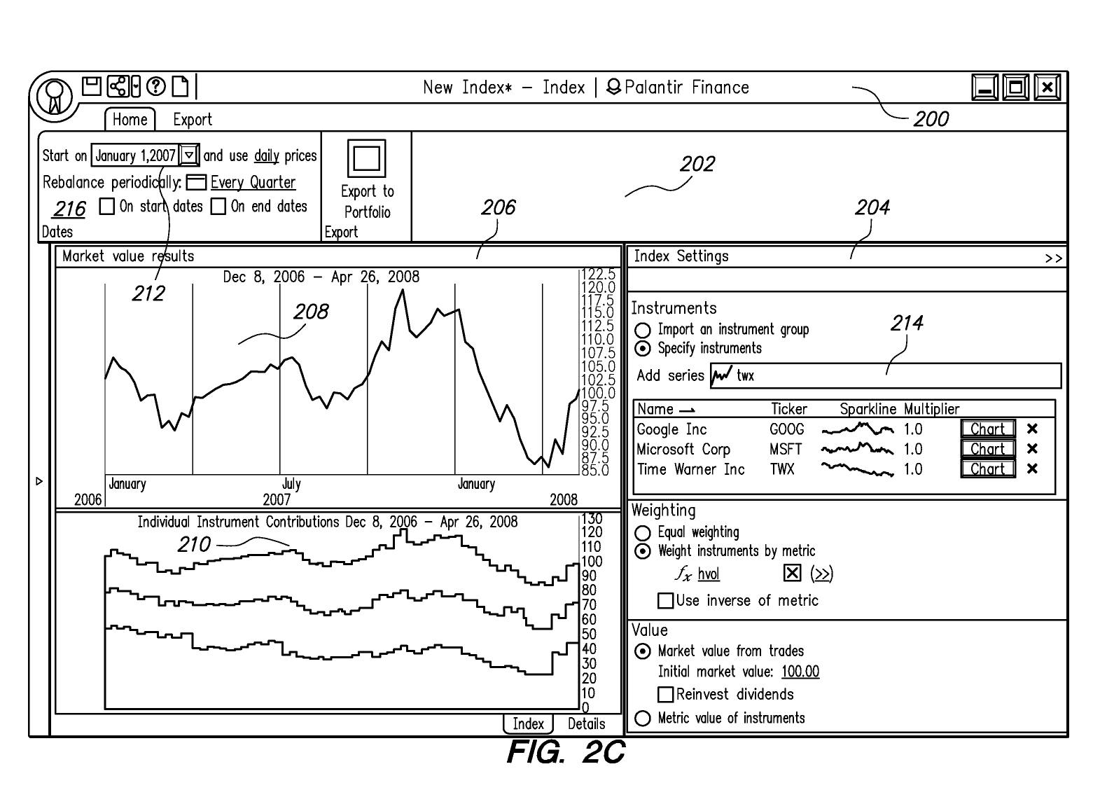

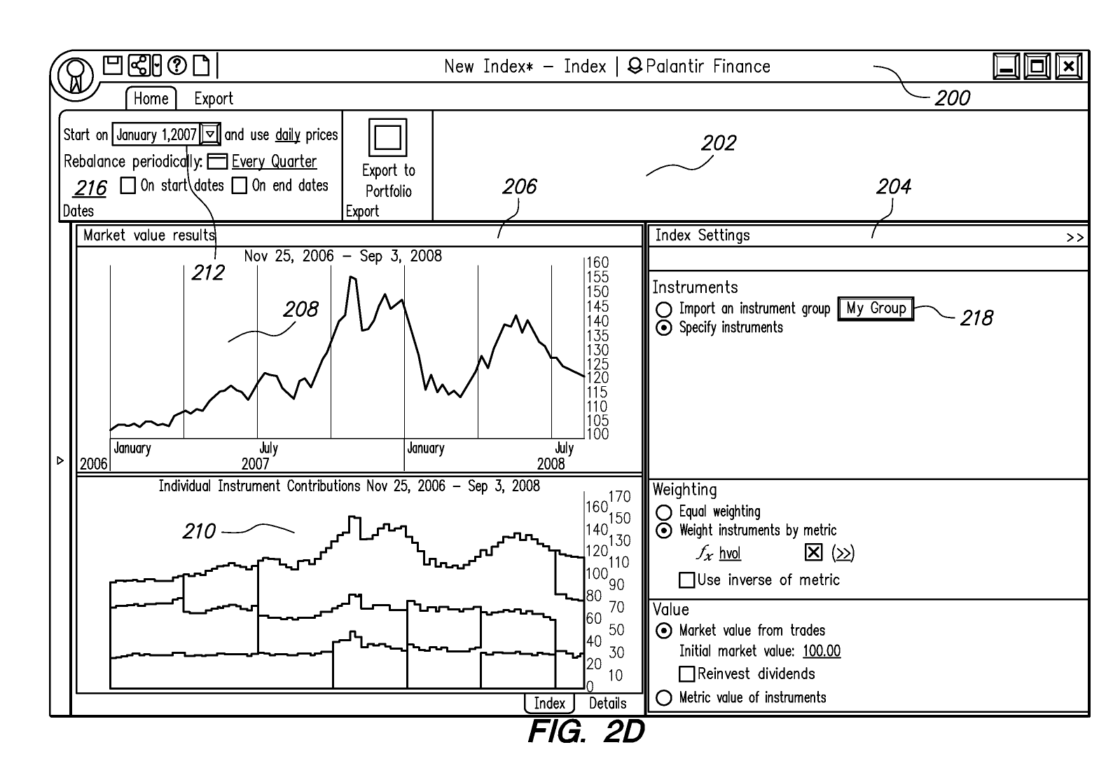

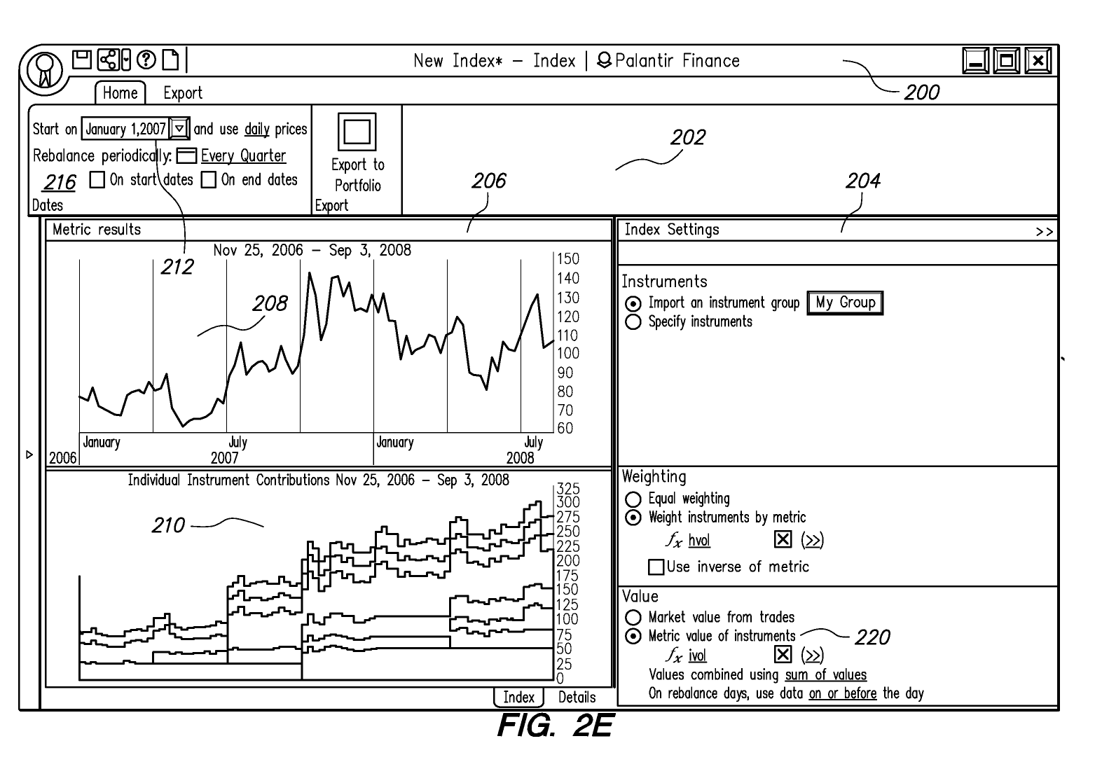

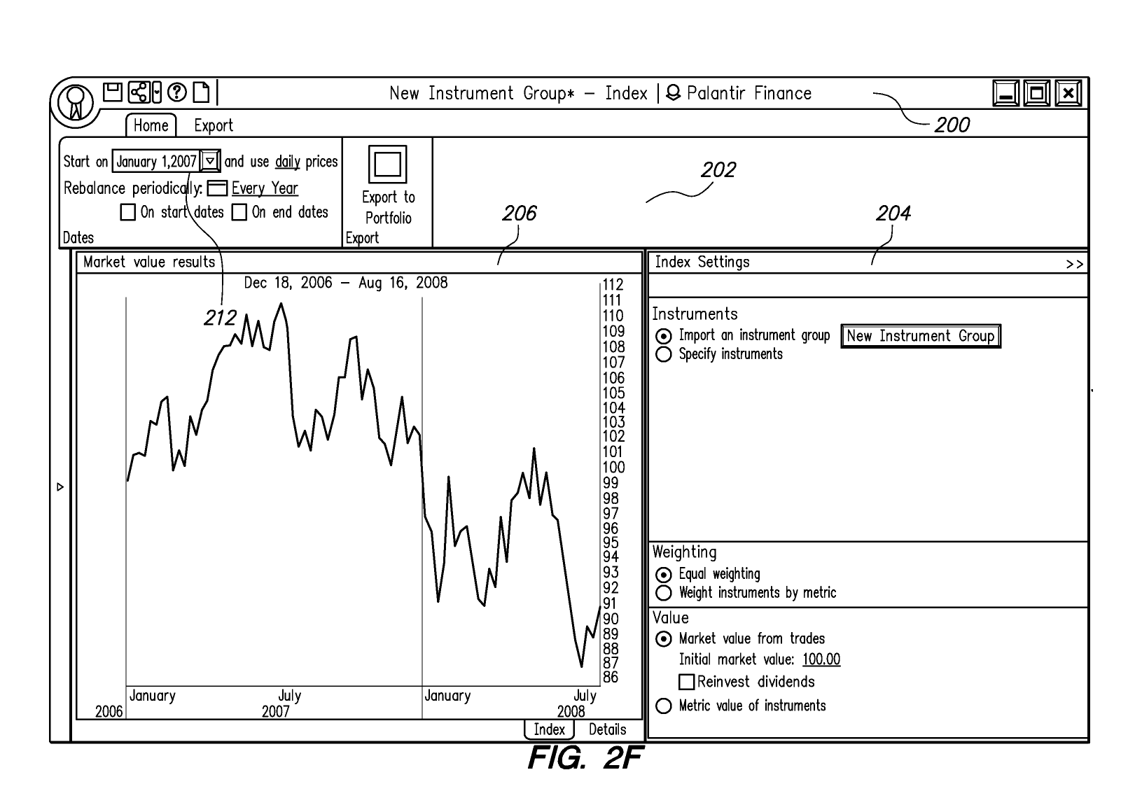

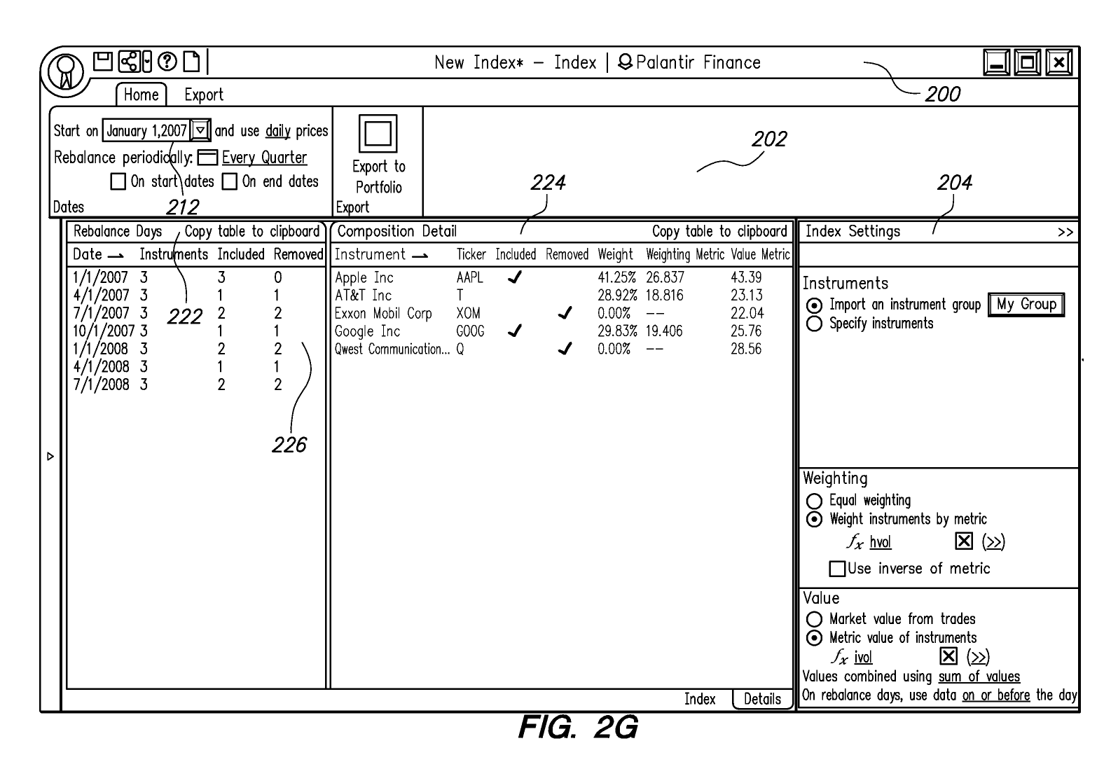

The user may use an example graphical user interface 200 of FIG. 2A to provide input of user-specifiable index parameters to, and to view a representations of the index as generated by, the data analysis system 100. In an embodiment, the graphical user interface may be implemented as a set of program instructions which, when executed by one or more processors, are operable to render the graphical user interface on the display of a computer system.

In some embodiments, the set of program instructions operable to generate the graphical user interface may be included in a standalone application, which is also operable to perform the techniques described herein for dynamic indexing. In some embodiments, the set of program instructions operable to generate the graphical user interface may be included in a client component of a client-server application, where the server component of the client-server application is operable to perform dynamic indexing as described herein. In some embodiments, the set of program instructions operable to generate the graphical user interface may be included in a server or service, where the server or service is operable to communicate instructions for rendering the graphical user interface and graphical representations of analytical results for dynamic indexing to a client which in turn is operable to display the graphical user interface on a display.

In the example embodiment illustrated in FIG. 2A, graphical user interface 200 comprises a plurality of graphic components including two control areas 202 (under the “Home” tab) and 204 (labeled as “Index Settings”) and a content pane 206 (presently labeled as “Market value results”; other labels may be also used). As used herein, graphic components may be included in frames.

As illustrated in FIG. 2A, the control area 202 comprises a number of settings that include an entry field 212 for the start date, which is currently set to Jan. 1, 2007. In some embodiments, a calendar may be provided to the user for the purpose of specifying the start date.

As illustrated in FIG. 2A, the control area 204 comprises a section labeled as “Value”. The checkable items therein are “Market value from trades” and “Metric value of instruments.” These labels are described for illustration purposes only; other ways of labeling these checkable items may be used in alternative embodiments. Further, other ways of presenting these options or similar options may be used in alternative embodiments. The illustrated checkable items are implemented as radio buttons in some embodiments, allowing only one of the items to be selected. As will be further explained, indexes created with dynamic indexing may, but are not limited to, track a collective market value of instruments included in the indexes. For example, a non-market value such as a collective volatility measure of the instruments may be tracked by an index in some embodiments. For the purpose of illustration only, the user has selected the checkable item “market value from trades”, with an initial market value of $100 as indicated in FIG. 2A.

As illustrated in FIG. 2A, the control area 204 also comprises a section labeled as “Instruments”. The checkable items therein are “Import an instrument group” and “Specify instruments.” As will be further explained, indexes created with dynamic indexing may, but are not limited to, consist of explicitly specified instruments by the user. For example, an index in some embodiments may consist of an instrument group. In alternative embodiments, an instrument group may itself consist of another instrument group and one or more explicitly specified instruments. For the purpose of illustration only, the user has selected the checkable item “Specify instruments.”

Using an “Add series” entry field 214, a user may explicitly specify which instruments are to be included in the index. A list of instruments may be provided to the user for selection. In some embodiments, selectable instruments may be ordered in a hierarchy that is based on certain ontological properties of the instruments. Selectable instruments may come from various markets, countries, regions, sectors, etc. For the purpose of illustration, the user has specified “Google Inc” and “Microsoft Corp” as the instruments to be included in the index. In an example embodiment, these specified instruments are listed below the “Add series” entry field 214.

In the user may specify a start date in Simple Index with a static list of instruments is displayed. A start date is specified on top, and the index is never rebalanced. Instruments (Google, Microsoft) are equally weighted. $100.0 is invested initially and performance is computed.

As illustrated in FIG. 2A, the control area 204 further comprises a section labeled as “Weighting”. The checkable items therein are “Equal weighting” and “Weight instruments by metric.” The “Equal weighting” checkable item, which may be the default choice, instructs the data analysis system 100 to divide the initial value equally among the instruments in the index. As will be further explained, instruments in an index may, but are not limited to, receive equal weights. For the purpose of illustration only, the user has selected the checkable item “Equal weighting.”

For the purpose of illustration, the content pane 206 of FIG. 2A presently consists of two subpanels 208 and 210. Subpanel 208 displays the collective value that is tracked in the index as a function of time, while subpanel 210 displays individual market values of the instruments in the index as functions of time. In some embodiments, subpanels 208 and 210 displays these functions of time in a time window corresponding to a section of time from the start date to an end date. The user may scroll to view the tracked values of the index and instruments therein in a different section of time. Other functions such “zoom-in”, “zoom-out”, color assignment, etc., may also be provided to the user for displaying these functions of time.

3.4 Weighting Criteria and Use of Weight Values

The user may assign different weight values to the instruments in the index. For example, weight values for instruments may depend on one or more metrics.

As illustrated in FIG. 2B, the user selects the checkable item “Weight instruments by metric.” Further, the user specifies an “hvol” metric as the weighting metric. Attributes of a particular metric, or other metrics, may be available for specification by the user. For example, in an embodiment, selecting a graphic component labeled “>>” causes the system to display a list of parameters of the associated metric; for example, for the “hvol” metric, a parameter is the number of days in a moving window. Alternatively, the user may click on a graphic component labeled “>>” to see a list of these other metrics.

Once a metric is selected, the use has an option to specify a proportional relationship between the metric and the weight values, or an inversely proportional relationship there between. As illustrated in FIG. 2B, a checkbox labeled “Use inverse of metric” is provided. Checking this checkbox informs the data analysis system 100 that the user selects the inversely proportional relationship, rather than the proportional relationship, the latter of which may be the default.

Under the proportional relationship, the weight values are directly proportional to the respective values of the metric of the instruments in the index. Thus, in the present example as illustrated in FIG. 2B, the index consists of two instruments, i.e., “GOOG” and “MSFT”. If the respective values of the “hvol” metric of the instruments are 2 and 1, in the order of “GOOG” and “MSFT”, then the weight values for these instruments are also 2 and 1 in the same order. In some embodiments, the weight values may be normalized so that the sum of the weight values for all individual instruments in the index adds up to 1.

The weight values thus derived may apply to the distribution of the initial value among the instruments. Thus, in the present example, on the start date, “GOOG” and “MSFT” are allocated $100*2/3, and $100/3 respectively.

Under the inversely proportional relationship, the weight values (or “weights”) that are used in a weighting criteria such as “hvol” are inversely proportional to the respective values of the metric of the instruments in the index. Thus, in the present example as illustrated in FIG. 2B, the index consists of two instruments, i.e., “GOOG” and “MSFT”. If the respective values of the “hvol” metric of the instruments are 2 and 1, in the order of “GOOG” and “MSFT”, then the weights for these instruments are proportional to the inverses of 2 and 1, i.e. 1/2 and 1/1 in the same order. As noted, the weights may be normalized so that the sum of the weights for all individual instruments in the index adds up to 1.

Thus, in the present example, under the inversely proportional relationship, on the start date, “GOOG” and “MSFT” are allocated $100/3, and $2*100/3, respectively.

For the purpose of illustration only, a collective value of the market values tracked in the index and market values of individual instruments are displayed in content pane 206.

For the purpose of illustrating a clear example, it has been shown that weights may be assigned equally or based on a metric. In some embodiments, the user may provide methods that are callable by the data analysis system, each of which methods computes weighting criteria in a different way from those built-in methods of allocating weights. Thus, not only metrics, whether built-in or user-provided, may be specified to produce weight values for the purpose of distributing a collective value at a certain time point (e.g., the initial value at a start date) to the instruments included in the index, but different methods or objects may also be used and/or specified to compute such weight values.

3.5 Rebalancing

Instruments may trade up or down. The data analysis system 100 provides users an option to rebalance instruments in an index from time to time.

To accomplish rebalancing of instruments in an index, a date set comprising a set of dates defined by fixed criteria or dynamic criteria may be used by a user to specify when operations may be performed. Rebalancing occurs on the exact dates specified in the date set. For example, as shown in FIG. 2C, a graphic component 216 on control pane 202 may be used by the user to specify a date set for rebalancing. For the purpose of illustration, the user has specified that rebalancing should occur periodically in every quarter, as indicated by the “Every Quarter” link. Further, rebalancing optionally occurs on the start date specified in the index, as shown by start date 212. In addition, each instrument may have a series start date and a series end date, which refers to rebalancing when the individual instrument starts and ends; for example, the end date may be used to cause rebalancing when an instrument is delisted from an exchange.

For the purpose of illustration, the index consists of three instruments, i.e., “GOOG”, “MSFT”, and “TWX”. On the start date of the index, i.e., Jan. 1, 2007, the initial value of $100 is invested in the instruments based on weight values derived from a proportional relationship between the weight values and a “hvol” metric. The market values of instruments may go up and down. On the rebalancing date, which is the end date of, of a first period, the data analysis system 100 virtually liquidates the instruments and obtains a new sum equal to the collective value of the index. Subsequently, the data analysis system determines a set of weighting criteria that is in effect for the index and applies to the new sum for the purpose of redistributing the new sum among the instruments in the index in accordance with the new set of weighting criteria. This rebalancing, unless altered by the user, occurs every period until the end date for the index.

For the purpose of illustrating a clear example, it has been described that rebalancing may be performed periodically in each period, but in other embodiments, rebalancing may occur on any dates that the user specifies, for example, in a date set, as rebalancing dates. Furthermore, the output weight values of the weighting criteria at the starting date of the index (i.e., Jan. 1, 2007 in the examples so far) may be different than at rebalancing dates. Additionally and/or alternatively, the output weight values from the weighting criteria for one rebalancing date may be different than those for another rebalancing date.

Rebalancing may occur when an instrument is permanently delisted from markets, or otherwise has ceased to be traded, but still has a residual value (for example, when a company whose shares are the instrument is acquired by another company). In the first scenario, the residual value is hold in the index as cash. In the second scenario, the data analysis system may determine a set of weighting criteria for the remaining instruments in the index and re-assign the residual value to the remaining instruments according to their weight values. The user may specify which scenario should occur. The data analysis system may default to rebalancing the remaining instruments in the index using a determinable set of weighting criteria or weight values. It should be noted that a set of weighting criteria to be applied when any of the instruments in the index is no longer traded may be, but does not have to be, the same as that of weighting criteria to be applied in other situations.

Rebalancing may also occur when a company whose shares are an instrument in the index experiences other events that may impact its trade value. For example, the company may spin off new companies or distribute dividends, or may be paid a premium in order to be acquired by another company. In some embodiments, the data analysis system 100 uses some default strategies to deal with these events. Additionally and/or alternatively, the data analysis system 100 may allow the user, in advance or after an event occurs, to specify how the data analysis system should do (e.g., whether to rebalance using weighting criteria for the remaining instruments) when these events occur.

3.6 Instrument Groups

An instrument group allows a user to include any instruments that satisfy a query that returns a set of instruments, rather than an explicit set of instruments. The query may return a different set of instruments when it is run on different dates. Accordingly, the user does not need to explicitly specify any individual instruments to be included in the index. Rather, the user may specify the query. The data analysis system evaluates the query to generate instruments to be included in the index at any given time between the start date of the index and the end date of the index.

For example, a query may specify selection criteria for instruments that are most active in a certain period of time. Alternatively, a query may specify selecting any instruments that appreciate the most. Other types of selection criteria may be used. Thus, the user does not specify individual instruments in the index. Instead, the data analysis system may evaluate the query and determine what instruments are in the dynamic instrument group as defined by the query on each of the rebalancing dates. Then, for each such date, the data analysis system 100 determines a set of weighting criteria and applies the weighting criteria to the instruments in the dynamic instrument group on that date.

For the purpose of illustration, an instrument group named “My Group” has been specified in connection with a graphic component 218 in control pane 204, as illustrated in FIG. 2D. This instrument group may specify that instruments must perform above a certain threshold for the past year ending on the date when the evaluation of instrument group. The data analysis system 100 saves all the definition data for the instrument group as specified by the user (with a different graphical user interface, perhaps). For the purpose of illustration, rebalancing occurs every quarter on the last day of quarter. Thus, on each last day of a quarter in the entire time window of the index, the definition data for the “My Group” instrument group is retrieved by the data analysis system 100. Using the definition data, the data analysis system evaluates the instrument group as follows. First, the past year performance of all the instruments is determined. Subsequently, instruments (e.g., top 1% of all the instruments) that are to be included in the instrument group on each such day are determined. The data analysis system 100 thereafter may determine a set of weighting criteria and apply the weighting criteria to these top performing instruments that have been included in the instrument group.

Thus, the index may start out with “GOOG” and “MSFT”, change into “GOOG” and “YHOO”, change again into “YHOO” and “AAPL”, etc. In addition, weighing criteria for each phase of the instrument group may, but are not limited to, be different from other phases.

For the purpose of illustrating a clear example, it has been described that an instrument group may be specified by instruments' performance metrics. In other embodiments, other ways of specifying an instrument group and other types of membership criteria may be used in defining instruments.

3.7 Analytical Value

For the purpose of illustration, it has been described that an index can be used to track investment performance using a collective market value of included instruments in the index. The collective market value may use the closing price of the instruments such as those used in S&P Index. The collective market value may also use other types of prices for the instruments to track a collective market value that is not tracked by any commercial index. However, instead of displaying an index that shows the investment results over a certain time period, a dynamic index may be used to track different types of values that may or may not have a certain relationship to a collective market value of included instruments in the index. For example, for the purpose of financial analysis, a user may be interested in changes of historical volatility over a time period. In various embodiments, the user may also use other metrics that may or may not indicate how well an investment will be over a time period. A collective value that is not based on market values of the included instruments in the index is termed as “an analytical value.” An index tracking an analytical value is termed as “an analytical index.” An index tracking a collective market value is termed as “an investment index.”

In some embodiments, two or more indexes may share a same composition of instruments and other index parameters, except that some of these indexes tracks a collective market value, while some others tracks analytical values. For example, two indexes may be used to track the “My Group” instrument group discussed previously. One of the two indexes may be an investment index that is used to track the closing prices of the included instruments in the instrument group over a particular time period. Thus, this index will indicate how well an investment portfolio in this instrument group performs over the particular time period. The other of the two indexes may be an analytical index used to track an indicator of the market in connection with the instrument group for the same time period. For example, this analytical index may be used to track volatility of the trading prices for the included instruments in the instrument group. In some embodiments, additional indexes may be used to track various indicators of an instrument group or a collection of instruments.

For the purpose of illustration, an instrument group named “My Group” has been specified in connection with a graphic component 218 in control pane 204, as illustrated in FIG. 2E. For the purpose of illustration, rebalancing occurs every quarter on the last day of quarter.

In some embodiments, the user selects the “Metric value of instruments” checklist item 220 in the “Value” subpanel, to track a metric value of included instruments in the index. For the purpose of illustration, the user has selected an “ivol” metric, which measures implied volatility of an instrument. Other metrics may also be available for the user to select as a metric value to be tracked in the index, in place of the “ivol” metric.

For the purpose of illustration, the index may start out with “GOOG” and “MSFT”, change into “GOOG” and “YHOO”, change again into “YHOO” and “AAPL”, etc. In some embodiments, metric values of all instruments in the index are summed up to yield a collective analytical value for each day in the time period tracked by the index. In some embodiments, weighing criteria for the instruments are applied in the summation. Thus, if in a phase when the instrument group consists of “GOOG” and “MSFT”, and if weight values for “GOOG” and “MSFT” are 2 and 1, then the “ivol” metric value of the “GOOG” instrument receives twice as much weight as that of the “MSFT” instrument.

For the purpose of illustrating a clear example, it has been described that metric values of included instruments in an index may be summed up to yield an analytical value for the index. In other embodiments, other aggregation methods of metric values may be used for the purpose of computing an analytical value for an index. For example, an analytical value for the index may be chosen by the user as a mean, rather than a sum, of all metric values of the included instruments. An analytical value may also be chosen by the user as a maximum, a minimum, a medium, a harmonic mean, etc., of all metric values of the included instruments. In a particular embodiment, an aggregate operation (e.g., mean) chosen by the user may be weighted (i.e., a weighted average) based on the weighting criteria specified by the user.

3.8 Composition Detail Chart

As shown in FIG. 2A through FIG. 2E, content pane 206 consists of two sub-panes 208 and 210. Sub-pane 208 displays the collective value as a function of time over a time section, while sub-pane 210 displays individual market values or metric values of the included instruments in the index as functions of time over the same time section, where the individual market values or metric values produce the collective value with weighting criteria or without (i.e., equal weighting). When the index has a high number of instruments, or a highly changeable collection of instruments, or when the index has a high number of rebalancing, the data analysis system provides the user an ability to view composition details in additional graphical user interface frames.

In some embodiments, a user may choose not to display sub-pane 210. For example, in FIG. 2F, only an overall index is displayed in content pane 206.

In some embodiments, the user may click on a “detail” graphic component in FIG. 2A through 2F and causes the graphical user interface to display detailed composition of the index as shown in FIG. 2G. In FIG. 2G, a content pane 222 displays a list of rebalance dates, which may be scrollable if the list is long. Each row in the list indicates detailed information for a rebalancing date. The detailed information in some embodiments comprises a date, a number of instruments in the index after rebalancing, a number of instruments joining the index after rebalancing, and a number of instruments removed from the index after rebalancing. A user may select a row in the list to see further details about a particular rebalancing. For the purpose of illustration, the user has selected a rebalancing (226 of FIG. 2G) that occurs on Jul. 1, 2007. As a result of this selection, a content pane 224 of FIG. 2G displays additional details about the selected rebalancing.

The content pane 224 provides information for all instruments involved in the selected rebalancing. In some embodiments, the instruments are displayed as a list, each row of which represents one of the instruments. In some embodiments, information in a row of the list comprises a full name of an instrument, the instrument's ticker, an first indication (under the column heading “Included”) whether the instrument is newly included in the index after the rebalancing, a second indication (under the column heading “Removed”) whether the instrument is to be removed from the index after the rebalancing, and a weight (under the column heading “Weight”) given to the instrument by weighting criteria currently in effect. Additionally and/or optionally, other information (such as a metric value that is used to calculate and/or normalize the weight and a contribution by the instrument to the collective value, etc.) may be provided for the instrument as represented in a row in content pane 224.

Thus, through a suitable graphical user interface display such as illustrated in FIG. 2G, the user may be provided detail composition information for an index.

4. Example Process Flow

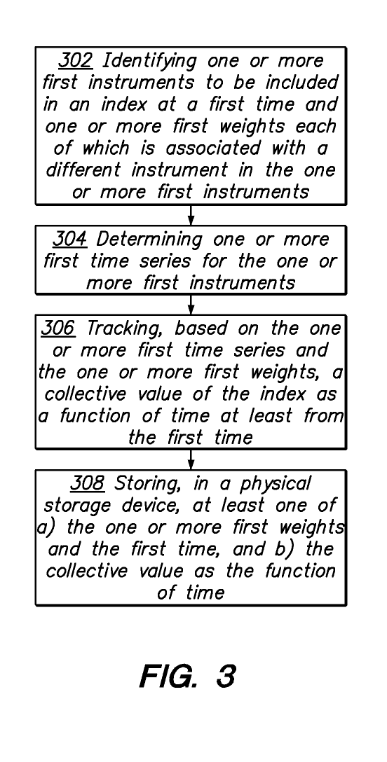

FIG. 3 illustrates an example process that uses dynamic indexing to track a collective value of instruments. This example process interacts with a user using a graphical user interface. Various information of an index may be rendered in a graphic representation of the index on the graphical user interface, which may be located at a different physical computing device from an application server that provides the information.

Initially, in block 302 of FIG. 3, a data analysis system such as 100 of FIG. 1 identifies one or more first instruments to be included in an index at a first time. In addition, the data analysis system 100 identifies one or more first weights each of which is associated with a different instrument in the one or more first instruments.

In block 304 of FIG. 3, the data analysis system 100 determines one or more first time series for the one or more first instruments.

In block 306 of FIG. 3, the data analysis system 100 tracks, based on the one or more first time series and the one or more first weights, a collective value of the index as a function of time at least from the first time. In some embodiments, the index is an investment index in which the collective value is the total market value of the included instruments. Thus, the index comprises a fraction of a total market value from each instrument in the one or more first instruments. In some embodiments, a fraction from such an instrument may be weighted by a weight that is associated with the instrument.

Alternatively, the index may be an analytical index as discussed previously. In some embodiments, besides the-sum-of-values method as described above, the collective value of the index at a given time may be calculated using various aggregate methods. These aggregate methods may compute a sum, a weighted sum, a harmonic means, etc. as discussed in detail previously.

In block 308 of FIG. 3, the data analysis system 100 stores, in a physical storage device, at least one of a) the one or more first weights and the first time, and b) the collective value as the function of time.

In some embodiments, the example process of FIG. 3 may further comprise additional steps for rebalancing instruments in the index. In these additional steps, the data analysis system 100 allows a user to identify one or more second instruments to be included in the index at a second time and one or more second weights each of which is associated with a different instrument in the one or more second instruments; determines one or more second time series for the one or more second instruments; and tracks, based on the one or more second time series and the one or more second weights, the collective value of the index as the function of time after the second time.

In some embodiments, the first time may be the start date for the index, while the second time above may be a date that a user specifies as a part of a date set. In some embodiments, a rebalancing at a particular time specified in the date set may be different from another rebalancing at another particular time specified in the date set. For example, the date set specifies a first method to calculate the one or more first weights and a second method to calculate the one or more second weights. Any, or all, of methods specified in the date set may be provided by built-in functions of the data analysis system 100 or by end user of the data analysis system after system deployment.

In some embodiments, an instrument is removed from the index when its associated weight is given zero, thereby causing the instrument to no longer contribute to the collective value in the index after rebalancing.

Conversely, in these embodiments, a previously non-included instrument is incorporated into the index when its associated weight is given a non-zero, thereby causing the instrument to contribute the collective value in the index after rebalancing.

The user may select included instruments explicitly by interacting with a suitable graphical user interface display such as 200 of FIG. 2A. Alternatively, the user may implicitly select instruments by specifying an instrument group as part, or all, of the included instruments in the index.

5. Extensions and Alternatives

Dynamic indexing according to the techniques described herein is not limited to any particular tool or any particular type of instruments. Thus, the examples of dynamic indexing provided herein are to be regarded in an illustrative rather than a restrictive sense.

6. Example Implementation Hardware

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio wave and infrared data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector can receive the data carried in the infrared signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method, comprising:
identifying one or more first instruments to be included in an index at a first time and one or more first weights each of which is associated with a different instrument in the one or more first instruments;
determining one or more first time series for the first instruments;
tracking, based on the one or more first time series and the one or more first weights, a collective value of the index as a function of time at least from the first time; and
storing, in a physical storage device, at least one of a) the first weights and the first time, and b) the collective value as the function of the time.

2. The method of claim 1, further comprising associating the index with a computational metric that defines a function that can operate on the first instruments as input and yield metric output values, and determining the one or more first weights based on a relationship to the metric output values for the instruments.

3. The method of claim 2, wherein the one or more first weights are determined as proportional to the metric output values.

4. The method of claim 2, wherein the one or more first weights are determined as inversely proportional to the metric output values.

5. The method of claim 2, further comprising determining the one or more first weights based on a relationship of market values of the first instruments at a particular time.

6. The method of claim 2, wherein the function is not market value.

7. The method of claim 1, further comprising:
receiving user input that identifies one or more second instruments to be included in the index at a second time, and one or more second weights, each of which is associated with a different instrument in the one or more second instruments;
receiving second user input that specifies a date set;
for each date in the date set, rebalancing the index based on determining a collective market value of the first instruments at that date, removing the first instruments from the index, adding the second instruments to the index, and using the second weights to distribute the collective market value among the second instruments.

8. The method of claim 7, further comprising performing the rebalancing on end dates of one or more of the first instruments.

9. The method of claim 7, further comprising receiving user input requesting data details for the index; in response to the user input, displaying a table comprising dates of the date set, a number of instruments in the index on each of the dates, a number of instruments included in the index on each of the dates, and a number of instruments removed from the index on each of the dates.

10. The method of claim 9, further comprising receiving user input selecting one of the dates in the table, and in response, displaying for each of the first instruments and the second instruments: instrument name; an indication whether that instrument was included in the index on the selected date; an indication whether that instrument was removed from the index on the selected date; and an instrument weight value for that instrument at the selected date.

11. The method of claim 1, wherein the index is tracked over a period of time that starts from the first time.

12. The method of claim 1, wherein the first time series is derived from a date set.

13. The method of claim 1, wherein the first instruments are received by evaluating a query, which specifies instrument selection criteria, at the first time, and wherein the second instruments are received by evaluating the query at the second time.

14. The method of claim 13, further comprising receiving user input that explicitly specifies one or more additional instruments to include in the index.

15. The method of claim 1, wherein the collective value is a market value of the index.

16. The method of claim 1, wherein the collective value is an analytical value of the index.

17. The method of claim 1, wherein the collective value of the index at a given time is one of a) a sum, b) a weighted average, and c) a harmonic mean, based on all instruments included in the index at the given time.

18. The method of claim 1, further comprising rendering a graphic representation of the index at a different physical computing device.

19. A machine-readable storage medium comprising one or more program instructions recorded thereon, which instructions, when executed by one or more processors, cause the one or more processors to perform:
identifying one or more first instruments to be included in an index at a first time and one or more first weights each of which is associated with a different instrument in the one or more first instruments;
determining one or more first time series for the first instruments;
tracking, based on the one or more first time series and the one or more first weights, a collective value of the index as a function of time at least from the first time; and
storing, in a physical storage device, at least one of a) the first weights and the first time, and b) the collective value as the function of the time.

20. The medium of claim 19, wherein the one or more program instructions further comprise instructions which, when executed by one or more processors, cause the one or more processors to perform associating the index with a computational metric that defines a function that can operate on the first instruments as input and yield metric output values, and determining the one or more first weights based on a relationship to the metric output values for the instruments.

21. The medium of claim 19, wherein the one or more program instructions further comprise instructions which, when executed by one or more processors, cause the one or more processors to perform:
receiving user input that identifies one or more second instruments to be included in the index at a second time, and one or more second weights, each of which is associated with a different instrument in the one or more second instruments;
receiving second user input that specifies a date set;
for each date in the date set, rebalancing the index based on determining a collective market value of the first instruments at that date, removing the first instruments from the index, adding the second instruments to the index, and using the second weights to distribute the collective market value among the second instruments.

22. The medium of claim 21, wherein the one or more program instructions further comprise instructions which, when executed by one or more processors, cause the one or more processors to perform receiving user input requesting data details for the index; in response to the user input, displaying a table comprising dates of the date set, a number of instruments in the index on each of the dates, a number of instruments included in the index on each of the dates, and a number of instruments removed from the index on each of the dates.

23. The medium of claim 22, wherein the one or more program instructions further comprise instructions which, when executed by one or more processors, cause the one or more processors to perform receiving user input selecting one of the dates in the table, and in response, displaying for each of the first instruments and the second instruments:
instrument name; an indication whether that instrument was included in the index on the selected date; an indication whether that instrument was removed from the index on the selected date; and an instrument weight value for that instrument at the selected date.

24. The medium of claim 19, wherein the first instruments are received by evaluating a query, which specifies instrument selection criteria, at the first time, and wherein the second instruments are received by evaluating the query at the second time.

25. The medium of claim 19, wherein the collective value is an analytical value of the index.

26. A computer-based apparatus comprising:
a network interface that is coupled to a data network for receiving one or more packet flows therefrom;
a processor; and
one or more program instructions which, when executed by the processor, cause the processor to perform:
identifying one or more first instruments to be included in an index at a first time and one or more first weights each of which is associated with a different instrument in the one or more first instruments;
determining one or more first time series for the first instruments;
tracking, based on the one or more first time series and the one or more first weights, a collective value of the index as a function of time at least from the first time; and
storing, in a physical storage device, at least one of a) the first weights and the first time, and b) the collective value as the function of the time.

27. The apparatus of claim 26, wherein the one or more program instructions further comprise instructions which, when executed by one or more processors, cause the one or more processors to perform associating the index with a computational metric that defines a function that can operate on the first instruments as input and yield metric output values, and determining the one or more first weights based on a relationship to the metric output values for the instruments.

28. The apparatus of claim 26, wherein the one or more program instructions further comprise instructions which, when executed by one or more processors, cause the one or more processors to perform:
receiving user input that identifies one or more second instruments to be included in the index at a second time, and one or more second weights, each of which is associated with a different instrument in the one or more second instruments;
receiving second user input that specifies a date set;
for each date in the date set, rebalancing the index based on determining a collective market value of the first instruments at that date, removing the first instruments from the index, adding the second instruments to the index, and using the second weights to distribute the collective market value among the second instruments.

29. The apparatus of claim 28, wherein the one or more program instructions further comprise instructions which, when executed by one or more processors, cause the one or more processors to perform receiving user input requesting data details for the index; in response to the user input, displaying a table comprising dates of the date set, a number of instruments in the index on each of the dates, a number of instruments included in the index on each of the dates, and a number of instruments removed from the index on each of the dates.

30. The apparatus of claim 29, wherein the one or more program instructions further comprise instructions which, when executed by one or more processors, cause the one or more processors to perform receiving user input selecting one of the dates in the table, and in response, displaying for each of the first instruments and the second instruments: instrument name; an indication whether that instrument was included in the index on the selected date; an indication whether that instrument was removed from the index on the selected date; and an instrument weight value for that instrument at the selected date.

31. The apparatus of claim 26, wherein the first instruments are received by evaluating a query, which specifies instrument selection criteria, at the first time, and wherein the second instruments are received by evaluating the query at the second time.

32. The apparatus of claim 26, wherein the collective value is an analytical value of the index.
